(19) United States
(12) Patent Application Publication
(10) Pub. No.: US 2018/0129963 A1
(43) Pub. Date: May 10, 2018

(54) APPARATUS AND METHOD OF BEHAVIOR FORECASTING IN A COMPUTER INFRASTRUCTURE

(71) Applicant: SIOS Technology Corporation, Lexington, SC (US)

(72) Inventor: Sergey A. Razin, Columbia, SC (US)

(73) Assignee: SIOS Technology Corporation, Lexington, SC (US)

(21) Appl. No.: 15/808,343

(22) Filed: Nov. 9, 2017

Related U.S. Application Data
(60) Provisional application No. 62/419,780, filed on Nov. 9, 2016.

(51) Int. Cl. G06N 7/00; G06N 5/02; G06N 99/00

(52) U.S. Cl. CPC G06N 7/005; G06F 9/45533; G06N 99/005; G06N 5/022

(57) ABSTRACT

Embodiments of the innovation relate to an apparatus and method of behavior forecasting in a computer infrastructure. The method includes, for each computer environment resource of the computer infrastructure having a related attribute, deriving a set of clusters for the related attribute of each associated computer environment resource and detecting a learned behavior boundary associated with each set of clusters for each associated computer environment resource. The method includes combining the learned behavior boundaries associated with each set of clusters for each associated computer environment resource to generate a resulting attribute pattern associated with the computer infrastructure; applying an attribute pattern threshold to the resulting attribute pattern; and identifying a forecasted behavior of the computer infrastructure based upon the application of the attribute pattern threshold to the resulting attribute pattern.

### RELATED APPLICATIONS

This patent application claims the benefit of U.S. Provisional Application No. 62/419,780, filed on Nov. 9, 2016, entitled, “Apparatus and Method of Behavior Forecasting in a Computer Infrastructure,” the contents and teachings of which are hereby incorporated by reference in their entirety.

### BACKGROUND

Modern economies and business services typically run complex, dynamic, and heterogeneous Information Technology (IT) computer infrastructures. For example, computer infrastructures can include one or more servers or host devices and one or more storage arrays interconnected by communication devices, such as switches or routers. The server devices can be configured to execute one or more virtual machines (VMs) during operation. Each VM can be configured to execute or run one or more applications or workloads. Such workloads can be executed as part of on-premise (datacenter) and off-premise (public/private cloud) environments.

During operation, performance issues can affect applications executed in cloud/virtualization environments and service levels associated with the infrastructure. As a result, systems administrators utilize a variety of monitoring and management tools to detect and address these performance issues.

### SUMMARY

As provided above, conventional monitoring and management tools can provide a systems administrator with insight into the behavior of the computer infrastructure at a given time. However, these conventional tools do not provide an indication of operation of the computer environment resources, such as performance or other metrics associated with the computer infrastructure at a future time.

By contrast to conventional monitoring and management tools, embodiments of the present innovation relate to an apparatus and method of behavior forecasting in a computer infrastructure. In one arrangement, for a given attribute of a computer infrastructure, a host device is configured to generate an attribute pattern, such as a workload pattern, using Monte Carlo Simulation. The host device is further configured to arrange or stack the attribute patterns for the given attribute of the computer infrastructure to detect potential forecast issues within the computer infrastructure. Based upon the results of the detection, the host device is configured to display the forecast of the behavior of the computer infrastructure over time.

In one arrangement, the host device provides a forecast dashboard as part of a user interface which allows a systems administrator to have visibility into the behavior issues associated with the computer infrastructure. This can include the metrics of the computer infrastructure (e.g., the performance, efficiency, reliability, and capacity of the computer environment resources) in the future, such as seven days in advance, based on the current configuration of the environment. The results provided by the dashboard can allow the systems administrator to adjust the configuration of the computer infrastructure (e.g., location of the VMs, workloads, number of workloads, capacity, etc.) to minimize or prevent the forecasted issues.

Embodiments of the innovation relate to a method of behavior forecasting in a computer infrastructure. The method includes, for each computer environment resource of the computer infrastructure having a related attribute, deriving a set of clusters for the related attribute of each associated computer environment resource and detecting a learned behavior boundary associated with each set of clusters for each associated computer environment resource. The method includes combining the learned behavior boundaries associated with each set of clusters for each associated computer environment resource to generate a resulting attribute pattern associated with the computer infrastructure; applying an attribute pattern threshold to the resulting attribute pattern; and identifying a forecasted behavior of the computer infrastructure based upon the application of the attribute pattern threshold to the resulting attribute pattern.

Embodiments of the innovation relate to an apparatus for behavior forecasting in a computer infrastructure. In one arrangement, a host device includes a controller having a memory and a processor. The controller is configured to, for each computer environment resource of the computer infrastructure having a related attribute, derive a set of clusters for the related attribute of each associated computer environment resource and detect a learned behavior boundary associated with each set of clusters for each associated computer environment resource. The controller is configured to combine the learned behavior boundaries associated with each set of clusters for each associated computer environment resource to generate a resulting attribute pattern associated with the computer infrastructure. The controller is configured to apply an attribute pattern threshold to the resulting attribute pattern and identify a forecasted behavior of the computer infrastructure based upon the application of the attribute pattern threshold to the resulting attribute pattern.

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1 illustrates a schematic depiction of a computer system, according to one arrangement.

FIG. 2 illustrates a schematic depiction of the host device of FIG. 1 executing an analytics platform, according to one arrangement.

FIG. 3 illustrates a graph showing the application of a Monte Carlo sampling function to K-mean clustering, according to one arrangement.

FIG. 4 illustrates an attribute boundary combined from learned behavior boundaries, according to one arrangement.

FIG. 5 illustrates a graphical user interface, according to one arrangement.

FIG. 6 illustrates recommendations provided by the graphical user interface of FIG. 5, according to one arrangement.

### DETAILED DESCRIPTION

Embodiments of the present innovation relate to an apparatus and method of behavior forecasting in a computer infrastructure. In one arrangement, for a given attribute of a computer infrastructure, a host device is configured to generate an attribute pattern, such as a workload pattern, using Monte Carlo Simulation. The host device is further configured to arrange or stack the attribute patterns for the given attribute of the computer infrastructure to detect potential forecast issues within the computer infrastructure. Based upon the results of the detection, the host device is configured to display the forecast of the behavior of the computer infrastructure over time.

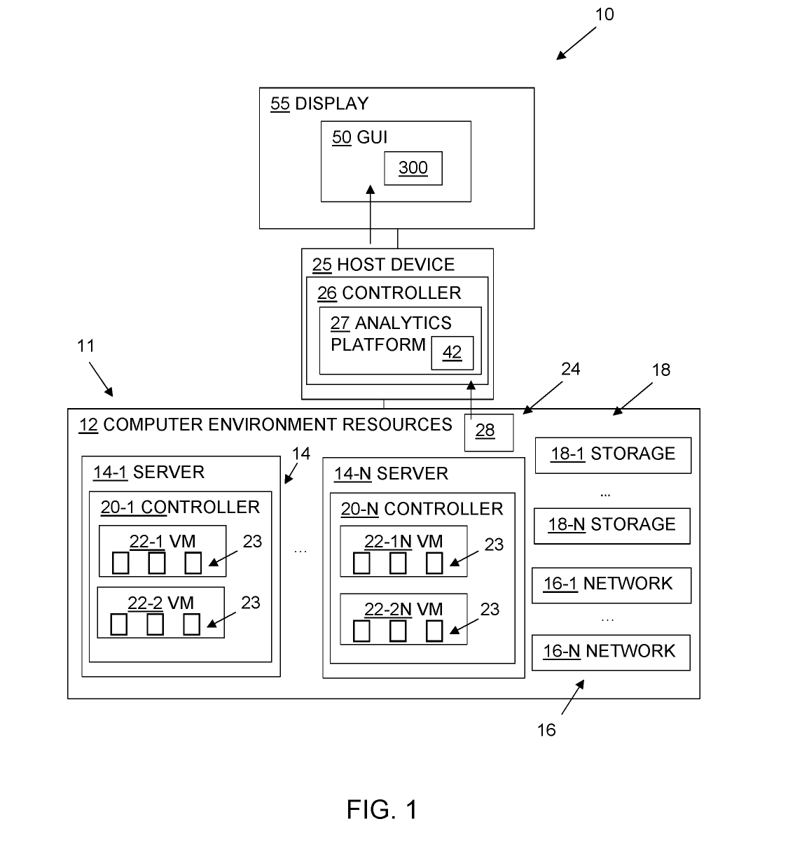

FIG. 1 illustrates an arrangement of a computer system 10 which includes at least one computer infrastructure 11 disposed in electrical communication with a host device 25. While the computer infrastructure 11 can be configured in a variety of ways, in one arrangement, the computer infrastructure 11 includes computer environment resources 12. For example, the computer environment resources 12 can include one or more server devices 14, such as computerized devices, one or more network communication devices 16, such as switches or routers, and one or more storage devices 18, such as disk drives or flash drives.

Each server device 14 can include a controller or compute hardware 20, such as a memory and processor. For example, server device 14-1 includes controller 20-1 while server device 14-N includes controller 20-N. Each controller 20 can be configured to execute one or more virtual machines 22 with each virtual machine (VM) 22 being further configured to execute or run one or more applications or workloads 23. For example, controller 20-1 can execute a first virtual machine 22-1 and a second virtual machine 22-2, each of which, in turn, is configured to execute one or more workloads 23. Each compute hardware element 20, storage device element 18, network communication device element 16, and application 23 is associated with an attribute of the computer infrastructure 11.

The host device 25 is configured as a computerized device having a controller 26, such as a memory and a processor. The host device 25 is disposed in electrical communication with one or more computer infrastructures 11, such as via a network connection, and with a display 55. In one arrangement, the host device 25 is configured to receive, via a communications port (not shown) a set of data elements 24 from at least one computer environment resource 12 of the computer infrastructure 11 where each data element 28 of the set of data elements 24 relates to an attribute of the computer environment resources 12. For example, each data element 28 can relate to the compute level (compute attributes), the network level (network attributes), the storage level (storage attributes), and/or the application or workload level (application attributes) of the computer environment resources 12. Further, each data element 28 of the set of data elements 24 can indicate a metric, such as a performance metric, efficiency metric, reliability metric, and capacity metric, associated with each attribute. For example, a data element 28 can indicate the storage capacity (e.g., an amount of available storage space), the storage performance (e.g., a utilization rate or latency), the storage reliability (e.g., a level of service), and/or the storage efficiency (e.g., an amount of waste) of each corresponding storage device 18-1 through 18-N of the computer infrastructure 11.

Further, the host device 25 is configured to forecast the behavior of the computer infrastructure 11 based upon a baseline set of data which identifies the attributes of the computer environment resources 12 as a model encapsulated in clusters. The following provides an example of the development of the baseline set of data.

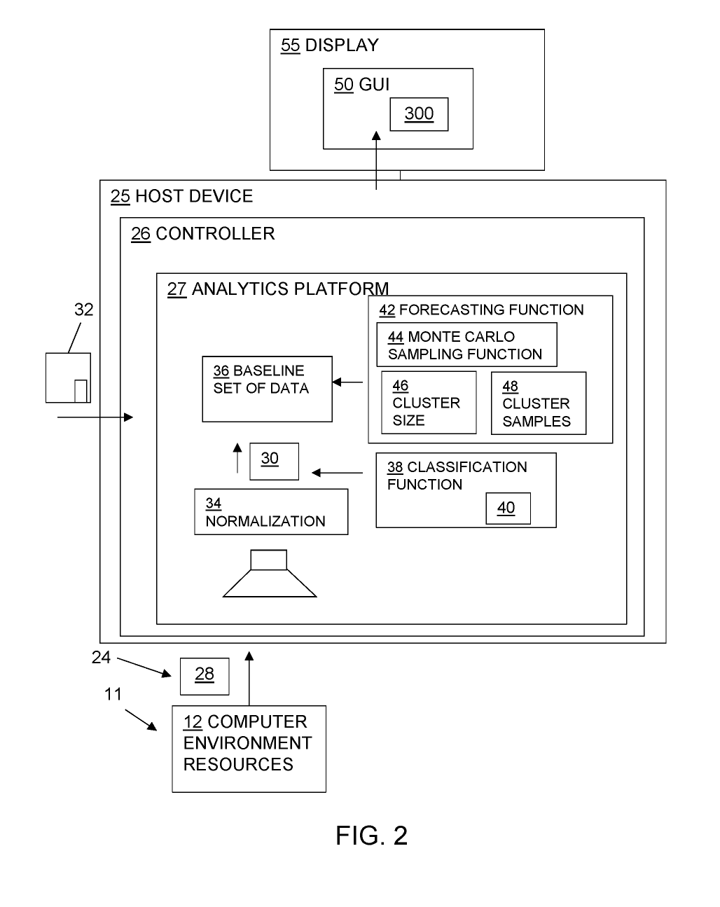

During operation, and with additional reference to FIG. 2, the host device 25 is configured to poll the computer environment resources 12, such as via private API calls, to obtain data elements 24 relating to the compute, storage, network, and application attributes of the computer infrastructure 11. For example, the host device 25 can receive data elements 24 that relate to the controller configuration and utilization of the servers devices 14 (i.e., compute attribute), the VM activity in each of the server devices 14 (i.e., application attribute), and the current state and historical data associated with the computer infrastructure 11. In one arrangement, each data element 28 can include additional information relating to the computer infrastructure 11, such as events, statistics, and the configuration of the computer infrastructure 11. For example, each data element 28 can include information relating to storage I/O related statistics from each server device 14, as well as statistics for the VMs 22 that are associated with a given datastore 29.

While the host device 25 can receive the data elements 24 from the computer infrastructure 11 in a variety of ways, in one arrangement, the host device 25 is configured to receive the data elements 28 from the computer infrastructure 11 as part of a substantially real-time stream. By receiving the data elements 24 as a substantially real-time stream, the host device 25 can monitor activity of the computer infrastructure 11 on a substantially ongoing basis. This allows the host device 25 to detect anomalous activity associated with one or more computer environment resources 12 over time.

As the host device 25 receives the data elements, an analytics platform 27, such as associated with the controller 26 of the host device 25, is configured to generate the baseline set of data 36. In one arrangement, as the host device 25 receives the data elements 24, the host device 25 is configured to utilize a uniformity or normalization function 34 as part of the analytics platform 27 to normalize the data elements 28. Application of the uniformity function to the data elements 24 generates normalized data elements 30. For example, any number of the computer environment resources 12 can provide the data elements 24 to the host device 25 in a proprietary format. In such a case, the normalization function 34 of the host device 25 is configured to convert or normalize the data elements 24 to a standard, non-proprietary format. In another example, as the host device 25 receives the data elements 24 over time, the data elements 24 can be presented with a variety of time scales. For example, for data elements 28 received from multiple network devices 16 of the computer infrastructure 11, the latency of the devices 16 can be presented in seconds (s) or milliseconds (ms). In such an example, the normalization function 34 of the host device 25 is configured to format the data elements 28 to a common time scale.

Normalization of the data elements 24 for application of a classification function 38, such as a clustering function 40 as described below, provides equal scale for all data elements 28 and a balanced impact on the distance metric utilized by the classification function (e.g., Euclidean distance metric). Moreover, in practice, normalization of the data elements 28 tends to produce clusters that appear to be roughly spherical, a generally desirable trait for cluster-based analysis.

Next, in one arrangement, the host device 25 is configured to apply, as part of the analytics platform 27, a classification function 38 to the normalized data elements 30 to develop the baseline set of data 36. While the classification function 38 can be configured in a variety of ways, in one arrangement, the classification function 38 is configured as a semi-supervised machine learning function, such as a clustering function 40.

Clustering is the task of grouping a set of objects in such a way that objects in the same group, called a cluster, are more similar to each other than to the objects in other groups or clusters. Clustering is a conventional technique for statistical data analysis, used in many fields, including machine learning, pattern recognition, image analysis, information retrieval, and bioinformatics. The grouping of objects into clusters can be achieved by various algorithms that differ significantly in their notion of what constitutes a cluster and how to efficiently find them. For example, known clustering algorithms include hierarchical clustering, centroid-based clustering (i.e., K-Means Clustering), distribution based clustering, and density based clustering. In one arrangement, based upon application of the clustering function 40, the host device 25 is configured to detect anomalies or degradation in performance as associated with the various components or attributes of the computer infrastructure 11.

With application of the clustering function 40 to the normalized data elements 30, the host device 25 stores the baseline set of data 36 as a model encapsulated in clusters. For example, the baseline set of data 36 defines and stores values for each cluster such as mean (e.g., a centroid of a cluster), standard deviation, a maximum x-axis value, a minimum x-axis value, a maximum y-axis value, a minimum y-axis value, size (e.g., the number of data points in the cluster), and a density function (e.g., the data point population density for a cluster) per object. As the maximum and minimum x-axis and y-axis values can apply to the x-axis (e.g., time) and y-axis (e.g., an attribute such as workload), the host device 25 can identify certain characteristics of the attribute, as well as the duration of the attribute, based on the height and width of the cluster.

As provided above, the host device 25 is configured to forecast the behavior of the computer infrastructure 11 based upon the baseline set of data 36 such as via a forecasting function 42. With continued reference to FIG. 2, the controller 26 of the host device 25 can store an application for the forecasting function 42. For example, the forecasting application installs on the controller 26 from a computer program product 32. In some arrangements, the computer program product 32 is available in a standard off-the-shelf form such as a shrink wrap package (e.g., CD-ROMs, diskettes, tapes, etc.). In other arrangements, the computer program product 32 is available in a different form, such downloadable online media. When performed on the controller 26 of the host device 25, the analytics platform application causes the host device 25 to perform the anomalous behavior analysis.

As provided above, using K-means clustering, the host device 25 can develop a baseline set of data 36 which identifies the attributes of the computer environment resources 12 as a model encapsulated in trained clusters and that characterizes the behavior of computer infrastructure attributes over time. In one arrangement of the system 10, the host device 25 is configured to leverage these trained clusters to forecast the future behavior of various attributes of the computer infrastructure 11. As will be described in detail below, the host device 25 can be configured to utilize Monte Carlo simulation and stacking to develop computer infrastructure patterns and to predict when aspects of the computer infrastructure 11 (e.g., storage, compute, etc.) will reach capacity.

Each cluster identifies areas of behavior of the computer infrastructure 11 and is defined within the baseline set of data 36 by a mean or centroid, maximum x-value, minimum x-value, maximum y-value, minimum y-value, standard deviation, size (e.g., the number of data points in the cluster), and a density function (e.g., the data point population density for a cluster). However, the baseline set of data 36 does not include actual data points for each cluster. In order to derive patterns associated with various attributes of the computer infrastructure 11, such as workload, for each computer environment resource 11 of the computer infrastructure 11 having the related attribute the host device 25 is configured to derive a set of clusters 80 for the related attribute of each associated computer environment resource 12.

In one arrangement, with reference to FIG. 2, the host device 25 is configured to utilize a Monte Carlo sampling function 44 to simulate the points within each cluster. For example, assume the case where the clusters of the baseline set of data 36 represent, as attributes, the workload behavior of each VM 22 within the computer infrastructure 11. In such a case, the host device 25 can be configured to apply the Monte Carlo sampling function 44 to the K-mean clustering information of the baseline set of data 36 (e.g., a listing of characteristic clusters) over a defined time segment for each VM workload 22 of the computer infrastructure 11. Use of Monte Carlo sampling simulates the workloads for each given VM and develops clusters based upon the K-mean clustering information of the baseline set of data 36.

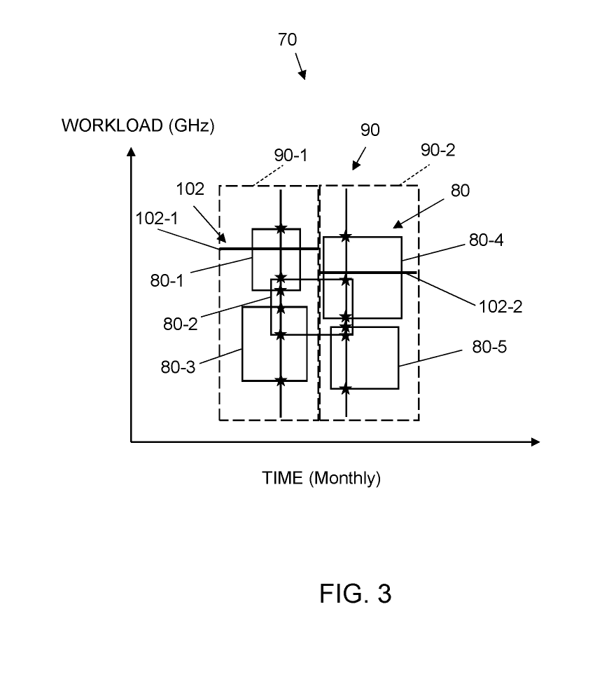

For example, FIG. 3 illustrates a set of clusters 80 developed for a first VM 22-1 of the computer infrastructure 11. Assuming a normal distribution of clusters and fully-populated clusters, based upon the mean value and standard deviation value for each cluster 80, the host device 25 is configured to generate data points associated with each cluster 80 using Monte Carlo sampling.

In one arrangement, as part of the Monte Carlo sampling, for each cluster listing of a given VM the baseline set of data 36, the host device 25 is configured to repeatedly select or sample random metric values for the VM 22-1. For example, the host device 25 is configured to generate each Monte Carlo sample for each cluster of the VM 22-1 in a given time segment by selecting a cluster from the listing of characteristic clusters as provided by the baseline set of data 36 at random and selecting or sample a value at random from the selected cluster. While any number of samples can be taken, in one arrangement, the number of samples to be used is approximately 1000.

Returning to FIG. 2, the cluster sampling frequency can be determined according to an appropriate probability distribution, such as determined by the relative cluster sizes 46. In one arrangement, the host device 25 can be configured to identify the relative size of each cluster 46 and generate random samples for each cluster 48 such that the random samples 48 are distributed within each cluster based upon the relative size of each cluster.

For example, with reference to FIG. 3, assume the host device 25 selects clusters 80-1, 80-2, and 80-3 for the application of the Monte Carlo sampling function 44. To detect the cluster size 46, of each cluster 80-1, 80-2, and 80-3, the host device 25 can review the baseline set of data 36 to determine the mean or centroid, maximum x-value, minimum x-value, maximum y-value, minimum y-value, standard deviation, size (e.g., the number of data points in the cluster), and density function for each. With the size of each cluster 80-1, 80-2, and 80-3 determined, the host device 25 is configured to apply the Monte Carlo sampling function 44 to each cluster 80-1, 80-2, and 80-3 based on these metrics.

For example, assume the set of three clusters 80-1, 80-2, and 80-3 has sizes {20, 40, 40} respectively. During application of the Monte Carlo sampling function 44, the hos device 25 is configured to apply sampling frequencies of {0.2, 0.4, 0.4}, respectively, since the first cluster 80-1 contains ⅕ of the total points (20/100) and each of the second and third clusters 80-2, 80-3 contains ⅖ of the total points (40/100). Once these values are determined, the host device 25 utilizes a framework that facilitates sampling. For example, the host device 25 can consider each relative frequency as a probability mass on the interval [0,1]. Accordingly, if the host device 25 selects a random value from [0,1], it should correspond to the first cluster 80-1 20% of the time, meaning that it should fall on a subinterval having a width of 0.2 (i.e., this may be [0.4,0.6] or [0.25, 0.45], etc.) which is mapped to the first cluster 80-1. Similarly, the host device 25 utilizes a subinterval of width 0.4 mapped to the second cluster 80-2 and another subinterval of width of 0.4 mapped to the third cluster 80-3.

In one arrangement, the cumulative frequencies can be a running total of the relative sizes, and for the example above, consists of {0.2, 0.6, 1.0}. Note that cluster order does not matter, as long as the mapping is correct. So for the example, the host device 25 can map the first cluster 80-1, the second cluster 80-2, and the third cluster 80-3 to the cumulative frequencies {0.4, 0.6, 1.0}. The host device 25 then proceeds with the sampling by selecting a random (e.g., uniform) value x from [0,1] and selecting the cluster mapped to the frequencies.

The host device 25 can be configured to apply the Monte Carlo sampling function 44 in a variety of ways. In one example, once a cluster 80 has been selected, the host device 25 selects a value at random from the cluster 80. Since the cluster is summarized by the mean (i.e, cMean) and standard deviation (i.e., cStddev) statistics, the host device 25 can regard the metric values in the cluster 80 as having a Gaussian (e.g., normal) distribution, for example, centered at cMean with variation determined by cStddev. For example, the host device 25 can be configured to draw a random sample x from the standard normal distribution (e.g., N(0,1) which identifies a Gaussian distribution centered at 0 with stddev=1). The host device 25 can then determine the sampleby computing cStddev*x+cMean.

With continued reference to FIG. 3, once the host device 25 has determined the Monte Carlo samples for the VM 22-1, the host device 25 is configured to then detect a learned behavior boundary 100 associated with each set of clusters 80 for each associated computer environment resource 12. For example, as will be described below, the host device 25 can develop a learned behavior boundary 100, such as a workload boundary, for any number of time intervals or time segments across a given timeframe.

FIG. 3 illustrates a graph 70 showing workload (GHz) as a function of time (monthly) for the first VM 22-1. For a given a set of clusters for a specific attribute, such as a workload or memory usage for a first VM 22-1, the host device 25 can delineate time intervals 90 (e.g., one hour) for which potential issues with performance can be predicted. For example, as provided above, using Monte Carlo sampling the host device 25 has developed a number of clusters 80 that relate to the workload of the first VM 22-1 over time. In one arrangement, in order to define a learned behavior workload boundary 100 for the entire timeframe (e.g., for the month), the host device 25 is configured to identify a set of time intervals 90 associated with each set of clusters 80 for the first VM 22-1 and perform a separate analysis on each identified time interval 90 to determine the boundary value 102 for that interval 90. This can be done by combining the mean value and the standard deviation value of overlapping clusters 80 for each interval 90 into a combined mean and combined standard deviation value.

For example, assume the host device 25 is configured to determine a workload boundary for a first VM 22-1 during a first time interval 90-1 between 12 PM and 1 PM on the first Tuesday of the month. As indicated in FIG. 3, based upon the Monte Carlo sampling, the host device 25 has defined five clusters 80-1 through 80-5 with three of the clusters 80-1, 80-2, and 80-3 are aligned vertically (e.g., that touch or overlap) within the first time interval 90-1. To determine the workload boundary for the first time interval 90-1 for the first VM 22-1, the host device 25 is configured to sum the random samples in each of the three overlapping clusters 80-1 through 80-3 within the first time interval 90-1 and take an average of the sum. The resulting average value represents the boundary value 102-1 of the first VM's workload for the time interval 90-1 between 12 PM and 1 PM on the first Tuesday of the month (e.g., the mean of the samples becomes the top point of a workload boundary graph).

The host device 25 is configured to perform this operation for the first VM 22-1 over a number of time intervals 90 associated with the VM 22-1. For example, with reference to FIG. 3, the host device 25 can determine a second boundary value 102-2 for a second time interval 90-2 between 1 PM and 2 PM. As illustrated, three of the clusters 80-4, 80-2, and 80-5 are aligned vertically and overlap within the second time interval 90-2. To determine the workload boundary for the first VM 22-1 during the second time interval 90-2, the host device 25 is configured to average the random samples of the three overlapping clusters 80-4, 80-2, and 80-5 within the second time interval 90-2. The resulting average value represents the boundary value 102-2 of the first VM's workload for the time interval 90-2.

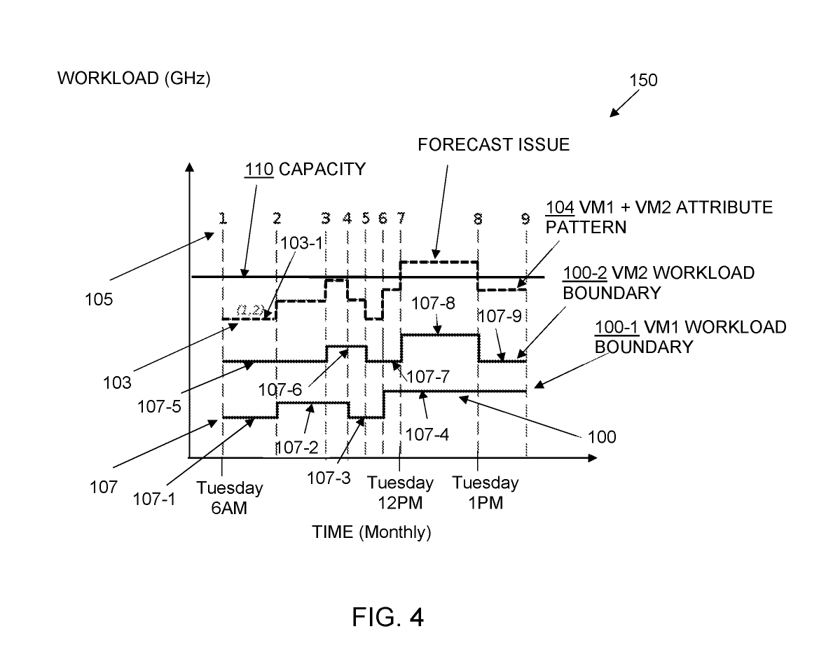

The host device 25 is configured to combine each boundary value 102 for each time interval 90 over all time intervals 90 across the entire timeframe (e.g., an entire month). Such a combination results in a learned behavior boundary 100, in this case a learned behavior workload boundary 100-1, for the first VM 22-1, such as illustrated by the graph 150 in FIG. 4.

The host device 25 is configured to repeat the process of determining the learned behavior boundary 100 for a given attribute, in this case VM workload, associated with each corresponding computer environment resource 12 of the computer infrastructure 11. For example, assume the case where the computer infrastructure 11 includes a second VM 22-2. Following the process of determining Monte Carlo samples for the clusters associated with second VM 22-2, the host device 25 can develop a series of workload boundary values 102 for each corresponding time interval 90. The host device 25 combines the boundary values 102 across all time intervals 90 for a given timeframe to form a learned behavior workload, boundary 100-2 associated with the second VM 22-2, as shown in FIG. 4.

The overall behavior of an attribute of the computer infrastructure 11 can be defined as the sum of the behaviors for a given attribute for each corresponding computer environment resource 12. Therefore, in the case where the attribute relates to VM workload behavior of the computer infrastructure 11, the host device 25 can combine or sum the VM learned behavior workload boundaries 100 to determine the overall workload behavior or attribute pattern of the computer infrastructure 11 over time. For example, with reference to the learned behavior workload boundaries 100-1, 100-2 developed for each VM workload 22-1 and 22-2 in FIG. 4, the host device 25 is configured to sum the learned behavior workload boundaries 100-1, 100-2 over the total time interval (e.g., one month) to generate a resulting attribute pattern 104 associated with the computer infrastructure 11. Such an approach allows the host device 25 to forecast the predicted workload of the computer infrastructure 11.

The host device 25 can be configured to combine the learned behavior boundaries 100 associated with a given attribute of the computer infrastructure 11 in a variety of ways. In one arrangement, as will be described below and with reference to FIG. 4, for each interval formed by a pair of contiguous endpoints, the host device 25 is configured to add corresponding learned behavior boundaries to define a corresponding threshold segment 103. The resulting collection of threshold segments 103 defines an overall attribute pattern 104 used in forecasting behavior of the attribute.

Initially, with reference to FIG. 4 the host device 25 is configured to identify a set of intervals 105 for the learned behavior boundaries 100 of the associated computer environment resources 12. For example, as shown, the host device 25 has generated learned behavior boundaries 100-1, 100-2 for each VM workload 22-1 and 22-2 of the computer infrastructure 11, respectively. Each workload boundary 100-1, 100-2 includes intervals 105 where each interval 105 can be defined as a boundary element 107 disposed between contiguous endpoints. For example, the first learned behavior workload boundary 100-1 includes intervals (1,2), (2,4), (4,6), and (6,9) defining corresponding boundary elements 107-1 through 107-4 while the second learned behavior workload boundary 100-2 includes intervals (1,3), (3,5), (5,7), (7,8), and (8,9) defining corresponding boundary elements 107-5 through 107-9.

In order to generate an overall attribute pattern 104, the host device 25 is configured to store the boundary elements 107 from each learned behavior workload boundary 100, 102 to an interval tree (not shown), such as stored by the host device 25 in memory. The host device 25 is further configured to store unique interval endpoints for the boundary elements 107 across all VMs into a list (not shown) that can be traversed in order, such as ascending order.

For each boundary element 107 formed by a pair of contiguous interval endpoints, the host device 25 is configured to access the interval tree to obtain a list of all boundary elements 107 that overlap a given interval 105. Based on the resulting list, the host device 25 is configured to combine (i.e., sum) the overlapping boundaries 107 for each associated computer environment resource 12 to generate corresponding threshold segments.

For example, as indicated in FIG. 4 the boundary element (1,2) 107-1 of the first learned behavior workload boundary 100-1 overlaps a portion of the boundary element (1,3) 107-5 of the second learned behavior workload boundary 100-2. Based upon a detection of the overlapping boundary elements 107, the host device 25 adds the boundary element (1,2) 107-1 of the first learned behavior workload boundary 100-1 to the boundary element (1,2) 107-5 of the second learned behavior workload boundary 100-2 to generate a resulting threshold segment (1,2) 103-1 of a resulting attribute pattern 104. The host device 25 repeats the process for subsequent overlapping boundary elements 107.

In one arrangement, after generating the resulting threshold segments 103, the host device 25 is configured merge adjacent segments 103 that have the same magnitude. The resulting collection of segments constitute the resulting attribute pattern 104 (i.e., the combined workloads of the first and second VMs 22-1, 22-2) used for forecasting.

With the resulting attribute pattern 104 developed for the VMs of the computer infrastructure 11, the host device 25 is configured to apply an attribute pattern threshold 110 to the resulting attribute pattern 104 to identify a forecasted behavior of the computer infrastructure 11. In one arrangement, with continued reference to FIG. 4, the host device 25 is configured to compare the attribute pattern threshold 110 to the resulting attribute pattern 104.

In the case where a portion of the resulting attribute pattern 104 falls below the attribute pattern threshold 110, the host device 25 can identify a positive behavior associated with the computer infrastructure 11 for an associated timeframe. For example, based upon a comparison of the attribute pattern threshold 110 and the resulting attribute pattern 104, the host device 25 can identify the resulting attribute pattern 104 as falling below the attribute pattern threshold 110 on Tuesday between 6:00 AM and 12:00 PM. Based upon the result, the host device 25 can identify this timeframe as having no predicted issues and can provide the result as a notification 300 to a systems administrator regarding this forecasted behavior.

Further, in the case where a portion of the attribute pattern 104 falls above or exceeds the attribute pattern threshold 110, the host device 25 can identify a negative behavior associated with the computer infrastructure 11 for an associated timeframe. For example, based upon a comparison of the attribute pattern threshold 110 and the resulting attribute pattern 104, the host device 25 can identify the workload of the first and second VMs 22-1, 22-2 exceed the capacity threshold 110 on Tuesday between 12:00 PM and 1:00 PM. Based upon the result, the host device 25 can identify the computer infrastructure 11 as having excessive workload issues during this timeframe and can output this result as a notification 300 to a systems administrator regarding this forecasted behavior.

As part of the notification 300, such as illustrated in FIG. 1, the host device 25 can provide the systems administrator with additional information regarding the a negative behavior. For example, the host device 25 can identify the computer environment resources 12, such as first and second VMs 22-1, 22-2, associated with the negative behavior. Such notification 300 provides the systems administrator with the opportunity to adjust the operation of the first and second VMs 22-1, 22-2 during the time period indicated to limit or prevent the excessive workload issues. In another example, the host device 25 can generate a recommendation to resolve the negative behavior associated with the computer infrastructure 11 for the identified timeframe. For example, the host device 25 can provide suggestions to the systems administrator regarding moving the workloads of the VMs 22-1, 22-1 to alternate VMs within the computer infrastructure 11 to alleviate potential workload issues.

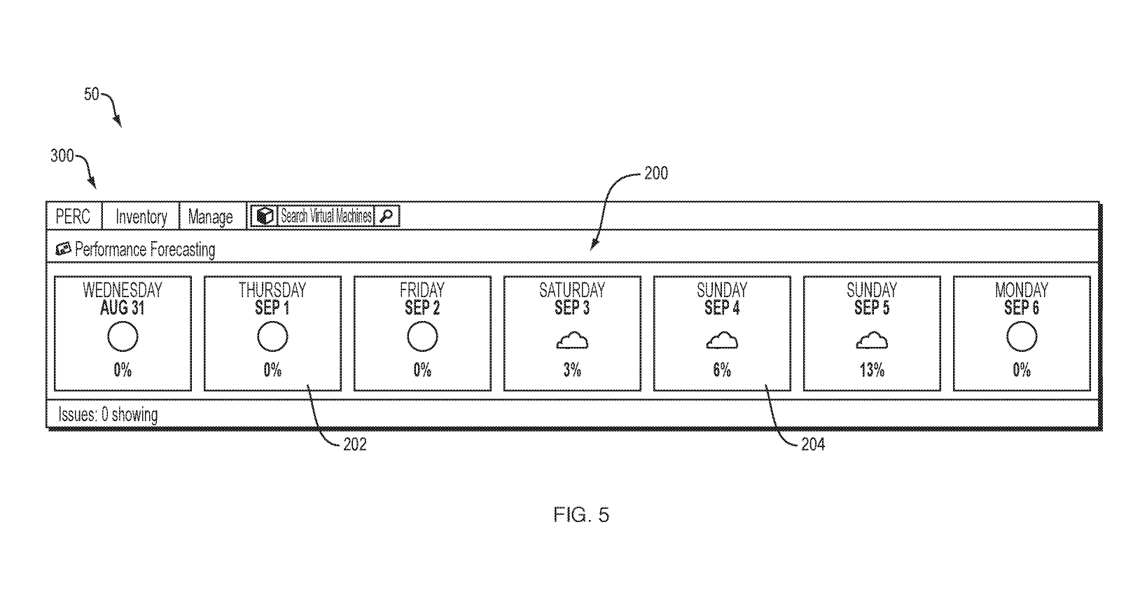

In one arrangement, the host device 25 is configured to provide the forecast notification 300 as part of a graphical user interface (GUI) 50 which visually identifies the forecasted behavior of the computer infrastructure. For example, with reference to FIG. 5, the GUI 50 can provide a day-by-day forecast 200 based upon the comparison of the attribute pattern threshold 110 and the attribute pattern 104. As illustrated, the host device 25 can show the forecast as sunny 202 when there are no predicted issues (e.g., workload issues) in the computer infrastructure 11 or cloudy 204 when there are predicted excessive attribute patterns or issues (e.g., workload issues) in the computer infrastructure 11. In the case where there is an issue, the systems administrator can select the cloudy forecast 204 to receive details regarding potential issues and potential solutions.

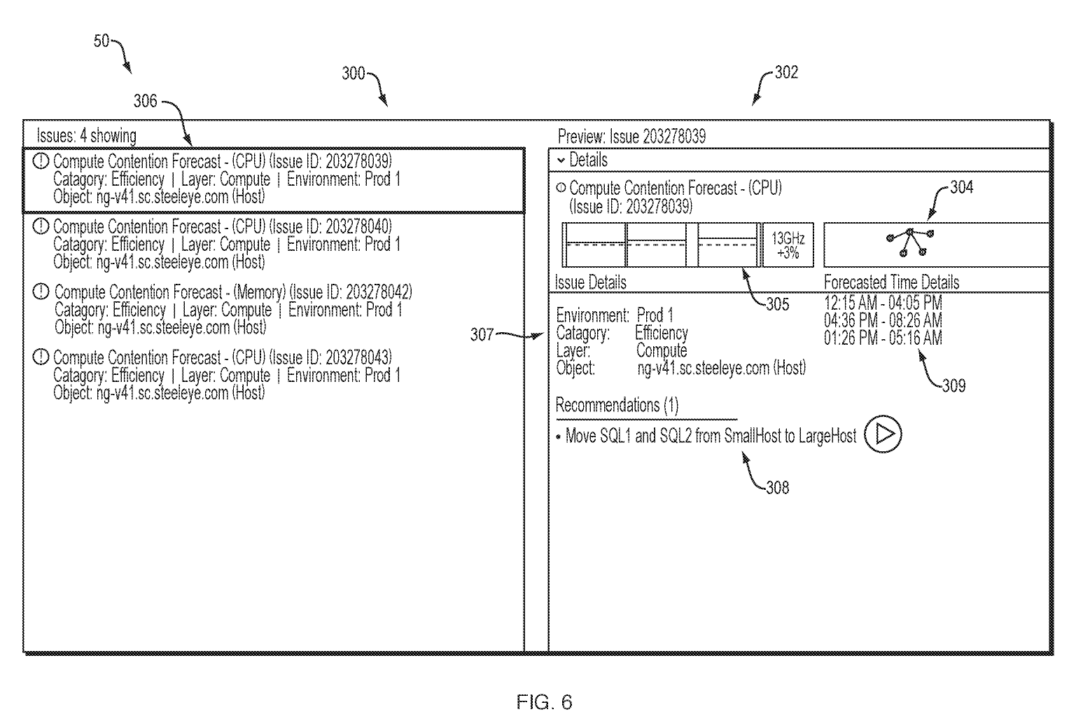

In one arrangement, as illustrated in FIG. 6, the host device 25 is configured to provide recommendations as part of the graphical user interface 50 in response to selection of the above-referenced cloudy forecast icon 204 by the systems administrator. In one arrangement, the GUI 50 can provide the details of the forecasted behavior 305, details of a source of an excessive attribute pattern within the computer environment 306, such as where the issue takes place (e.g., what host or storage device) as well as the computer environment resources impacted 304, details involving the issues 307, notification of a timeframe associated with the excessive attribute pattern 309, or a recommended solution 308 regarding the excessive attribute pattern (e.g., move VMs).

With the development of the attribute pattern 104 and comparison to the attribute pattern threshold 110, the host device 25 can provide a systems administrator with insight into the future behavior of the computer infrastructure 11 based upon its current operation. As such, the host device 25 can improve the operation of the computer infrastructure 11 by allowing the systems administrator to adjust the operation of the computer environment resources 12 prior to the occurrence of an issue.

While various embodiments of the innovation have been particularly shown and described, it will be understood by those skilled in the art that various changes in form and details may be made therein without departing from the spirit and scope of the innovation as defined by the appended claims.

1. In a host device, a method for forecasting a behavior of a computer infrastructure, comprising:
for each computer environment resource of the computer infrastructure having a related attribute:
deriving, by the host device, a set of clusters for the related attribute of each associated computer environment resource, and
detecting, by the host device, a learned behavior boundary associated with each set of clusters for each associated computer environment resource;
combining, by the host device, the learned behavior boundaries associated with each set of clusters for each associated computer environment resource to generate a resulting attribute pattern associated with the computer infrastructure;
applying, by the host device, an attribute pattern threshold to the resulting attribute pattern; and
identifying, by the host device, a forecasted behavior of the computer infrastructure based upon the application of the attribute pattern threshold to the resulting attribute pattern.

2. The method of claim 1, wherein deriving the set of clusters for the related attribute of each associated computer environment resource comprises deriving, by the host device, the set of clusters for the related attribute of each associated computer environment resource using Monte Carlo sampling.

3. The method of claim 2, wherein deriving the set of clusters for the attribute using Monte Carlo sampling comprises:
identifying, by the host device, a relative size of each cluster of the set of clusters;
generating, by the host device, random samples for each cluster of the set of clusters, the random samples distributed within each cluster based upon the relative size of each cluster of the set of clusters.

4. The method of claim 3, wherein detecting the learned behavior boundary associated with each set of clusters for each associated computer environment resource comprises:
identifying, by the host device, a set of time intervals associated with each set of clusters for each associated computer environment resource; and
for overlapping clusters for each time interval of the set of time intervals, averaging, by the host device, the random samples for each cluster to generate a boundary value for each time interval;
wherein the learned behavior boundary associated with each set of clusters for each associated computer environment resource comprises all boundary values across all time intervals of the set of time intervals.

5. The method of claim 1, wherein combining the learned behavior boundaries associated with each set of clusters for each associated computer environment resource to generate the resulting attribute pattern associated with the computer infrastructure comprises:
identifying, by the host device, a set of intervals for the learned behavior boundaries of the associated computer environment resources; and
for each interval of the set of intervals, summing, by the host device, the overlapping learned behavior boundaries of each associated computer environment resource to generate corresponding threshold segments;
wherein the resulting attribute pattern for the computer environment resources of the computer infrastructure comprises all threshold segments across all intervals of the set of intervals.

6. The method of claim 1, wherein:
applying the attribute pattern threshold to the resulting attribute pattern comprises comparing, by the host device, the attribute pattern threshold to the resulting attribute pattern; and
identifying the forecasted behavior of the computer infrastructure based upon the application of the attribute pattern threshold to the resulting attribute pattern comprises:
when a portion of the resulting attribute pattern falls below the attribute pattern threshold, identifying, by the host device, positive behavior associated with the computer infrastructure for an associated timeframe; and
when a portion of the resulting attribute pattern falls above the attribute pattern threshold, identifying, by the host device, negative behavior associated with the computer infrastructure for an associated timeframe.

7. The method of claim 6, wherein identifying negative behavior associated with the computer infrastructure for the associated timeframe further comprises identifying, by the host device, at least one computer environment resource associated with the negative behavior.

8. The method of claim 6, wherein identifying negative behavior associated with the computer infrastructure for the associated timeframe further comprises generating, by the host device, a recommendation to resolve the negative behavior associated with the computer infrastructure for the associated timeframe.

9. The method of claim 1, further comprising generating, by the host device, a notification regarding the forecasted behavior of the computer infrastructure based upon the application of the attribute pattern threshold to the resulting attribute pattern.

10. The method of claim 9, wherein generating the notification regarding the forecasted behavior of the computer infrastructure comprises providing, by the host device a graphical user interface (GUI) which visually identifies the forecasted behavior of the computer infrastructure.

11. A host device, comprising:
a controller comprising a memory and a processor, the controller configured to:
for each computer environment resource of the computer infrastructure having a related attribute:
derive a set of clusters for the related attribute of each associated computer environment resource, and
detect a learned behavior boundary associated with each set of clusters for each associated computer environment resource;
combine the learned behavior boundaries associated with each set of clusters for each associated computer environment resource to generate a resulting attribute pattern associated with the computer infrastructure;
apply an attribute pattern threshold to the resulting attribute pattern; and
identify a forecasted behavior of the computer infrastructure based upon the application of the attribute pattern threshold to the resulting attribute pattern.

12. The host device of claim 11, wherein deriving the set of clusters for the related attribute of each associated computer environment resource, the host device is configured to derive the set of clusters for the related attribute of each associated computer environment resource using Monte Carlo sampling.

13. The host device of claim 12, wherein when deriving the set of clusters for the attribute using Monte Carlo sampling, the host device is configured to:
identify a relative size of each cluster of the set of clusters;
generate random samples for each cluster of the set of clusters, the random samples distributed within each cluster based upon the relative size of each cluster of the set of clusters.

14. The host device of claim 13, wherein when detecting the learned behavior boundary associated with each set of clusters for each associated computer environment resource, the host device is configured to:
identify a set of time intervals associated with each set of clusters for each associated computer environment resource; and
for overlapping clusters for each time intervals of the set of time intervals, average the random samples for each cluster to generate a boundary value for each time interval;
wherein the learned behavior boundary associated with each set of clusters for each associated computer environment resource comprises all boundary values across all time intervals of the set of time intervals.

15. The host device of claim 11, wherein when combining the learned behavior boundaries associated with each set of clusters for each associated computer environment resource to generate the resulting attribute pattern associated with the computer infrastructure, the host device is configured to:
identify a set of intervals for the learned behavior boundaries of the associated computer environment resources; and
for each interval of the set of intervals, sum the overlapping learned behavior boundaries of each associated computer environment resource to generate corresponding threshold segments;
wherein the resulting attribute pattern for the computer environment resources of the computer infrastructure comprises all threshold segments across all intervals of the set of intervals.

16. The host device of claim 11, wherein:
when applying the attribute pattern threshold to the resulting attribute pattern, the host device is configured to compare the attribute pattern threshold to the resulting attribute pattern; and
when identifying the forecasted behavior of the computer infrastructure based upon the application of the attribute pattern threshold to the resulting attribute pattern, the host device is configured to:
when a portion of the resulting attribute pattern falls below the attribute pattern threshold, identify positive behavior associated with the computer infrastructure for an associated timeframe; and
when a portion of the resulting attribute pattern falls above the attribute pattern threshold, identify negative behavior associated with the computer infrastructure for an associated timeframe.

17. The host device of claim 16, wherein when identifying negative behavior associated with the computer infrastructure for the associated timeframe, the host device is further configured to identify at least one computer environment resource associated with the negative behavior.

18. The host device of claim 16, wherein when identifying negative behavior associated with the computer infrastructure for the associated timeframe, the host device is further configured to generate a recommendation to resolve the negative behavior associated with the computer infrastructure for the associated timeframe.

19. The host device of claim 11, wherein the host device is further configured to generate a notification regarding the forecasted behavior of the computer infrastructure based upon the application of the attribute pattern threshold to the resulting attribute pattern.

20. The host device of claim 19, wherein when generating the notification regarding the forecasted behavior of the computer infrastructure the host device is configured to provide a graphical user interface (GUI) which visually identifies the forecasted behavior of the computer infrastructure.

21. A computer program product encoded with instructions that, when executed by a controller of a host device, causes the controller to:
for each computer environment resource of the computer infrastructure having a related attribute:
derive a set of clusters for the related attribute of each associated computer environment resource, and
detect a learned behavior boundary associated with each set of clusters for each associated computer environment resource;
combine the learned behavior boundaries associated with each set of clusters for each associated computer environment resource to generate a resulting attribute pattern associated with the computer infrastructure;
apply an attribute pattern threshold to the resulting attribute pattern; and
identify a forecasted behavior of the computer infrastructure based upon the application of the attribute pattern threshold to the resulting attribute pattern.
